(19) United States
(12) Patent Application Publication
(10) Pub. No.: US 2024/0403685 A1
(43) Pub. Date: Dec. 5, 2024

(54) Quantum System and Method

(71) Applicant: University of Strathclyde, Glasgow (GB)

(72) Inventors: Gerard Pelegri, Glasgow (GB); Andrew Daley, Glasgow (GB); Jonathan Pritchard, Glasgow (GB)

(73) Assignee: University of Strathclyde, Glasgow (GB)

(21) Appl. No.: 18/742,896

(22) Filed: Jun. 13, 2024

Related U.S. Application Data
(63) Continuation of application No. PCT/GB2022/053321, filed on Dec. 20, 2022.

(30) Foreign Application Priority Data
Dec. 23, 2021 (GB) 2118944.4

(51) Int. Cl. G06N 10/40; G06N 10/20

(52) U.S. Cl. CPC G06N 10/40; G06N 10/20

(57) ABSTRACT

A method of performing a quantum gate operation using a quantum system wherein the quantum system comprises two or more neutral atoms, wherein each atom of the two or more neutral atoms is configured to transition between atomic states comprising: a first hyperfine ground state of the atom, a second hyperfine ground state of the atom, a Rydberg state and at least one intermediate excited state, wherein the quantum system further comprises an interaction between the Rydberg states of the two or more neutral atoms, and wherein the method comprises:
generating a pulse sequence and providing the generated pulse sequence to the two or more neutral atoms to transition the atoms between said atomic states, wherein the pulse sequence takes into account at least part of the hyperfine structure of the at least one intermediate atomic state.

### CROSS-REFERENCE TO RELATED APPLICATIONS

This application claims the benefit of priority under 35 U.S.C. § 120 as a continuation of PCT Application No.: PCT/GB2022/053321, filed Dec. 20, 2022, which claims the benefit of United Kingdom Patent Application No.: 2118944.4 filed on Dec. 23, 2021 both of which are incorporated herein by reference in their entireties.

### FIELD

The present invention relates to a quantum computing method and apparatus, in particular, a method of performing a quantum gate operation.

### BACKGROUND

A quantum computing apparatus for performing quantum information processing can be based on quantum circuit principles in which a quantum bit or “qubit” encodes quantum information. By analogy to digital circuits, these quantum circuits may use quantum logic gates (also referred to as quantum gates) as their building blocks. Different physical quantum systems or quantum phenomena may be used to implement such quantum gates.

An example of a physical quantum system that can be used to implement a quantum gate are neutral atoms. Indeed, over the last decade, trapped neutral atoms have emerged as one of the most promising platforms for quantum information processing. It has been demonstrated that reliable single atom loading, initialization and readout in configurable 1D, 2D and 3D optical arrays formed by up to a few hundred sites may be achieved without fundamental limitations for a further up-scaling.

Neutral atom qubits may mediate entanglement using Rydberg states. It is known to control quantum gates implemented using such Rydberg quantum systems with laser pulses. For example, in “Symmetric Rydberg controlled—Z gates with adiabatic pulses” by Saffman et. al (Physical Review A 101, 2021), two distinct approaches to performing high fidelity gates using Rydberg quantum systems are outlined. One of these approaches is based on Adiabatic Rapid Passage (ARP) with an analysis based on a single photon transition. In that approach, optimized analytical pulses were reported to yield Bell-state fidelities F>0.999 for a one-photon transition scheme. Such an approach in alkali atoms may pose problems such as the need to use stable high-power ultra-violet lasers and/or the presence of significant recoil backscattering.

### SUMMARY

According to a first aspect, there is provided a method of performing a quantum gate operation using a quantum system wherein the quantum system comprises two or more neutral atoms, wherein each atom of the two or more neutral atoms is configured to transition between atomic states comprising: a first hyperfine ground state of the atom, a second hyperfine ground state of the atom, a Rydberg state and at least one intermediate excited state, wherein the quantum system further comprises an interaction between the Rydberg states of the two or more neutral atoms, and wherein the method comprises: generating a pulse sequence and providing the generated pulse sequence to the two or more neutral atoms to transition the atoms between said atomic states, wherein the pulse sequence takes into account at least part of the hyperfine structure of the at least one intermediate atomic state.

The pulse sequence may be generated in accordance with a two-photon excitation protocol. The at least one intermediate state comprise at least one hyperfine component state. The at least one intermediate state may comprise the full hyperfine structure of the intermediate state. The pulse sequence may comprise at least one pulse. The at least one pulse of the pulse sequence may comprise at least one property that takes into account at least part of, optionally the full, hyperfine structure of the at least one intermediate state.

The method may further comprise preparing a quantum state. The prepared quantum state may be an entangled quantum state. The quantum gate may be a CNOT gate. The quantum gate may be a controlled phase gate. Quantum information may be encoded in the first and second hyperfine ground states of the two or more neutral atoms. The quantum gate operation may be a controlled quantum gate operation. The pulse sequence may be designed to include the full hyperfine structure or at least part of the hyperfine structure of the intermediate atomic state.

The at least one intermediate state of each atom may be represented by the atomic numbers: total angular momentum quantum number Jₑ and fixed angular quantum number I. The at least one hyperfine component of the intermediate state may be a state having a value of fₑ in the set fₑ=|Jₑ+I|, . . . , |Jₑ+I−1|, . . . , |Jₑ−I|. The full hyperfine structure may correspond to the set of hyperfine components having a value of fₑ in the set fₑ=|Jₑ+I|, . . . , |Jₑ+I−1|, . . . , |Jₑ−I|.

The one or more pulses of the pulse sequence may be provided to each atom of the two or more neutral atoms substantially simultaneously. The one or more pulses may be applied symmetrically to the two or more neutral atoms. The one or more pulses may be provided to each atom of the two or more neutral atoms such that the one or more pulses are incident on each atom of the two or more neutral atoms at substantially the same time. The two or more neutral atoms may be nearest neighbours.

The two or more neutral atoms may comprise at least a first neutral atom and a second neutral atom configured to transition between said atomic states. The two or more neutral atoms may comprise a first neutral atom and a second neutral atom configured to transition between said atomic states.

The first neutral atom may correspond to or represent a first quantum qubit. The second neutral atom may correspond to or represent a second quantum qubit. The first quantum qubit may be a control qubit and the second quantum qubit may be a target qubit. The first and second hyperfine ground states of the first and second neutral atoms may correspond to first and second computational states. The first and second quantum qubits may be encoded in hyperfine ground states.

The two or more neutral atoms may comprise a third neutral atom configured to transition between a corresponding set of atomic states and wherein the generated pulse sequence is provided to each of the first, second and third neutral atoms. The third neutral atom may correspond to or represent a third quantum qubit.

The two or more neutral atoms may comprise third and fourth neutral atoms configured to transition between a corresponding set of atomic states and wherein the generated pulse sequence is provided to each of the first, second, third and fourth neutral atoms. The third and fourth neutral atoms may correspond to or represent third and fourth quantum qubits. The two or more neutral atoms may comprise more than four neutral atoms. The two or more neutral atoms may comprise a plurality of neutral atoms corresponding to or representation a plurality of quantum qubits.

The first and second hyperfine ground states of the two or more neutral atoms may correspond to first and second computational states. The first and second quantum qubits may be encoded in hyperfine ground states.

The quantum gate operation may correspond to an evolution of the at least two neutral atoms between said atomic states. The pulse sequence may comprise at least one property based on a calculation or application of a model of the quantum system that includes an effect of at least one hyperfine component of the at least one intermediate state on said evolution. The quantum gate operation may correspond to the at least two neutral atoms transitioning between a sequence of atomic states. The at least one property may be based on a calculation or application of a model of the quantum system that includes an effect of at least one hyperfine component of the at least one intermediate state of the sequence of states. The at least one property may be based on a calculation or application of a model of the quantum system that includes an effect of at least one hyperfine component of the at least one intermediate state on the dynamics of the quantum system.

The at least one property may be determined using the model of the quantum system, wherein the model comprise a part that includes an effect of the at least one hyperfine component, optionally all of the hyperfine components of the at least one intermediate state. The model may comprise a part that models the effect of at least one hyperfine component of the at least one intermediate state on the transitions between atomic states. The part of the model may comprise a component of a mathematical object or a term.

The model may comprise a dynamical model of the quantum system. The model may represent a relationship between at least one parameter of the pulse sequence and the interaction between said atomic states. The dynamical model may take into account the dynamics of the quantum system including the hyperfine components of the intermediate state.

The quantum gate operation may correspond to a desired evolution of the quantum system between said atomic states. The at least one property of the pulse sequence may provide the desired evolution of the quantum system between said atomic states. The dynamical model may be used to calculate said at least one property of the pulse sequence that provides the desired evolution of the quantum system.

The quantum gate operation may correspond to a desired evolution of atomic states of the quantum system via atomic transitions. At least one pulse may comprise at least one property such that the pulse sequence provides the desired evolution of atomic states. The method may comprise providing the generated pulse sequence to the two or more neutral atoms thereby to distribute and/or transfer an electron population between at least the hyperfine ground states and the excited Rydberg states via hyperfine components of the intermediate state. The pulse sequence may comprise providing the generated pulse sequence to transfer an electron population to desired quantum states via the hyperfine components of the at least one intermediate state.

The model may comprise at least one part that is based on the frequency splitting of the hyperfine states such that the inclusion of said at least one term or portion changes at least one or more property of the pulse sequence. The dynamical model may comprise at least one term or part that models the dynamics of the transitions from the ground states to the Rydberg states via at least one hyperfine component of the at least one intermediate state.

The at least one property comprises at least one of: a shape, size, amplitude, frequency or duration of the pulse.

The method may further comprise selecting and/or varying an operational parameter of a pulse generator thereby to generate said pulse sequence having said at least one property.

The pulse sequence may be generated by a pulse generator. The pulse generator may comprise one or more lasers, preferably at least two lasers. The pulse generator may comprise associated optical apparatus, for example, steering optics or an optical modulation device. Selecting and/or varying an operational parameter of the pulse generator may comprise selecting and/or varying the operational parameters of the lasers and/or associated optical apparatus and/or optical modulation device.

The at least one property of the pulse sequence may be represented by one or more pulse parameters and the method comprises obtaining values for the one or more pulse parameters based on said calculation or applying the model.

The pulse sequence may comprise one or more adiabatic pulses. The pulse sequence may comprise adiabatic rapid pulses. The pulse sequence may comprise a chirped laser pulse characterised by a change in frequency. The pulse sequence may comprise performing an adiabatic sweep over frequencies. Generating the pulse sequence may comprise changing at least one of a frequency and/or an intensity of the laser.

The calculation or the application of the model may take into account quantum transitions from the hyperfine grounds states of the two or more neutral atoms to their respective Rydberg states that comprise a superposition of all allowed transitions to the hyperfine components of the at least one intermediate state. The at least one intermediate atomic state may be resolved into a plurality of intermediate hyperfine states.

At least one pulse of the sequence of pulses may be characterised by a frequency detuning curve, wherein the frequency detuning curve comprises at least one compensation feature to compensate for a perturbative effect on the one or more hyperfine components of the intermediate state. The perturbative effect may be a result of the application of an external laser. The perturbative effect may be an AC start shift. The compensation feature may comprise at least one of: a discontinuity, a rate of change, an adjustment in rate of change, a maxima, minima or turning point, a peak and/or a nadir.

The shape of the detuning curve may be bound by an adiabatic condition. The detuning curve may have a feature that that compensates for the AC shifts such that an effective two-photon detuning is smooth. The detuning curve may be selected so that the effective two-photon detuning is substantially smooth.

Generating the pulse sequence may comprise: controlling at least one laser to generate at least one chirped excitation pulse, where the chirped excitation pulse comprises a sweep over a range of frequencies that include at least the two-photon resonance frequency between the second hyperfine ground state and the Rydberg state.

Generating the pulse sequence may comprise:
a. generating a first pulse comprising a range of frequencies that is sufficient to non-resonantly couple the at least one intermediate atomic state and the Rydberg state and
b. generating a second pulse comprising a sweep over a range of frequencies that includes the resonant frequency between the first hyperfine ground state and the Rydberg state.

The range of frequencies may be dependent upon the effective linewidth of the two photon excitation. The pulse sequence may comprise a two-photon adiabatic rapid passage (ARP) protocol.

The quantum system may be represented by a first model having a first number of dimensions and wherein the pulse sequence is generated as part of a time dependent detuning process over a sufficiently large frequency range such that that the quantum system can be effectively represented by a second model having a second, lower, number of dimensions.

The pulse sequence may correspond to a detuning of the at least one intermediate state that is sufficiently large that an effective two-level description of the quantum system may be obtained through adiabatic elimination of the intermediate states. The pulse sequence may be such that the detuning of the at least one intermediate state has a value substantially larger than a Rabi frequency between the ground states and the at least one intermediate state. The pulse sequence may be such that the at least one intermediate state is far-off resonance such that the intermediate states can be eliminated via adiabatic elimination.

The detuning process may be such that the quantum system may be characterised by a single effective Rabi frequency and a single detuning parameter.

The quantum system may be a three level quantum system that may be effectively described using an effective Rabi frequency and a two-photon detuning. The method may comprise controlling one or more lasers to provide desired variations in these quantities.

The pulse sequence may be characterised by time-dependent changes in at least an effective Rabi frequency and a two-photon detuning parameter. The ranges of the effective Rabi frequency and two-photon detuning parameter may be bound by one or more adiabatic conditions.

The method may further comprise performing a further modulation to the generated pulse sequence.

The further modulation may be based on a quantum optimal control process.

The further modulation may comprise varying the at least one property of the at least one pulse of the pulse sequence. The at least one property may comprise the shape, amplitude, intensity, frequency and duration of the pulse. The further modulation may comprise varying pulse parameters to thereby modulate the time-dependent changes in the single effective Rabi frequency and the single detuning parameter. The method may further comprise determining at least one property or parameter of the pulse sequence based on a calculation or model that takes into account the full hyperfine structure of the at least one intermediate atomic state and further modulating the determined at least one pulse parameter based on a quantum optimal control process.

The quantum optimal control process may comprise obtaining pulse parameters to optimize a function that is representative of the quantum gate operation. The optimal pulse parameter may be determined by performing a numerical optimisation process to find optimal parameters. The numerical optimisation process may comprise applying a numerical solver to find said values for the pulse parameters. The quantum optimal control process may comprise obtaining pulse parameters by numerically optimising the parameters of an envelope function that is expanded as a sum of orthogonal functions. The optimized parameters may correspond to parameters representative of at least one property comprising: shape, size, amplitude, frequency, duration, Rabi frequency and detuning. The optimal parameters may be based on a Fourier expansion control.

The method according to any preceding claim, wherein the generated pulse sequence comprises first excitation pulses and second excitation pulses, wherein the first excitation pulses comprise first continuous wave laser light and the second excitation pulses comprises second continuous wave laser light.

The transitions between atomic states may comprise Rabi oscillations.

The method may further comprise providing the generated pulse sequence symmetrically to the two or more neutral atoms. The method may comprise providing the generated pulse sequence symmetrically to each of the two or more neutral atoms.

The two or more neutral atoms may comprise alkali atoms.

The two or more neutral atoms may comprise one of: sodium (Na), rubidium (Rb), caesium (Cs), and potassium (K) atoms.

The atomics state may be selected based on one or more laser parameters, for example, the line width and/or a maximum available laser power. The atomic states may be selected based on at least one of: laser operational parameters, type of neutral atom, configuration of the neutral atoms.

The method may further comprise maintaining the quantum system at a temperature approaching zero Kelvin. The quantum system may be maintained at a temperature such that the product of the Boltzmann constant and the temperature is lower than any relevant energy scale of the quantum system.

The generated pulse sequence may comprise energies based on the energy separation of the ground hyperfine levels and the intermediate and Rydberg states subject to a selected detuning value.

The method may comprise applying single qubit rotations as part of the pulse sequence. The method may comprise applying single qubit rotations in addition to the pulse sequence. The pulse sequence may be part of a two-photon excitation scheme that further comprises applying global phase rotations.

The Rydberg interaction between the Rydberg states of the two or more neutral atoms may prevent simultaneous excitation of the two or more neutral atoms to their respective Rydberg states.

The quantum gate operation may comprise preparing an entangled quantum state. Preparation of the entangled quantum state may be provided as part of a quantum gate protocol.

The one or more pulses of the pulse sequence may have a pulse duration in the range 1 to 1000 microseconds.

The pulse sequence may be generated by first and second lasers of a pulse generator. The first and second lasers may have maximum power of the laser are in the range 5 mW to 1000 mW, optionally in the range 5 mW to 500 mW, optionally in the range 5 mW to 300 mW. The first and second lasers may have a wavelength in the range between 300 nm and 1500 nm.

According to a second aspect, there is provided, a quantum computer apparatus comprising: a quantum system comprising two or more neutral atoms, wherein each atom of the two or more neutral atoms is configured to transition between atomic states comprising: a first hyperfine ground state of the atom, a second hyperfine ground state of the atom, a Rydberg state and at least one intermediate atomic state, wherein the quantum system further comprises an interaction between the Rydberg states of the two or more neutral atoms; a pulse generator configured to generate a pulse sequence and provide the generated pulse sequence to the two or more neutral atoms in accordance to transition the atoms between said atomic states, wherein the pulse sequence comprises at least one pulse comprising a property that takes into account at least part of the hyperfine structure of the at least one intermediate atomic state.

The pulse generator may comprise at least one pulse source. The pulse generator may comprise first and second pulse sources. The first and second pulse sources may comprise first and second lasers, respectively. The quantum computer apparatus may comprise a controller for controlling the excitation pulse generator.

According to a third aspect, there is provided a method comprising: performing a calculation to determine a pulse sequence for a quantum system, wherein the determined pulse sequence is such that a desired quantum gate operation is obtained, wherein the quantum system comprises two or more neutral atoms, wherein each atom of the two or more neutral atoms is configured to transition between atomic states comprising: a first hyperfine ground state of the atom, a second hyperfine ground state of the atom, a Rydberg state and at least one intermediate excited state, wherein the quantum system further comprises an interaction between the Rydberg states of the two or more neutral atoms, and wherein the calculation takes into account at least part of a hyperfine structure of the at least one intermediate state. The method may further comprise storing pulse sequence data representative of the determined pulse sequence.

The method may further comprise obtaining said pulse sequence data and using said obtained pulse sequence data to generate the determined pulse sequence.

The calculation may comprise using or applying a model of the quantum system. The calculation may comprise determining at least one property of at least one pulse of the pulse sequence. The model may comprise a part that includes the effect of at least one hyperfine component of the intermediate state on the at least one property.

In accordance with a fourth aspect, there is provided a data processing apparatus comprising a processor configured to perform the method of the third aspect.

In accordance with a fifth aspect, there is provided a non-transitory computer readable medium comprising instructions operable by a processor to perform the method of the third aspect.

In accordance with a sixth aspect, there is provided a method of performing a quantum gate operation using a quantum system wherein the quantum system comprises two or more neutral atoms, the two or more neutral atoms, wherein each atom of the two or more neutral atoms is configured to transition between atomic states comprising: a first hyperfine ground state of the atom, a second hyperfine ground state of the atom, a Rydberg state and at least one intermediate excited state, wherein the quantum system further comprises an interaction between the Rydberg states of the two or more neutral atoms. The quantum gate operation may correspond to a desired evolution of the quantum system transitions between the atomic states. The method may further comprise: obtaining pulse sequence data representative of the pulse sequence, wherein the pulse sequence data is based on a calculation using a model of the quantum system, wherein the model comprises at least one part that represents the behaviour and/or an effect of at least one hyperfine component of the at least one intermediate state on the dynamics of the quantum system, wherein the pulse sequence data comprises values for the effective Rabi frequency and two-photon detuning frequency that provide the desired evolution of the quantum system. The method may further comprise generating a pulse sequence in accordance with the obtained pulse sequence data and providing the generated pulse sequence to the two or more neutral atoms.

Features in one aspect may be provided as features in any other aspect as appropriate. For example, features of a method may be provided as features of an apparatus and vice versa. Any feature or features in one aspect may be provided in combination with any suitable feature or features in any other aspect.

### BRIEF DESCRIPTION OF DRAWINGS

Various aspects of the invention will now be described by way of example only, and with reference to the accompanying drawings, of which:

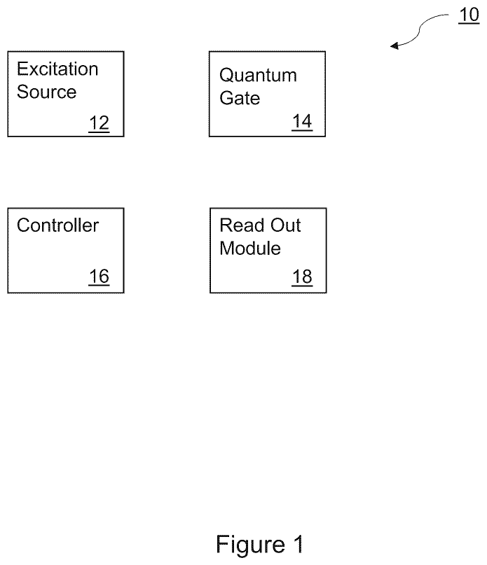

a. FIG. 1 is a schematic diagram of a quantum computing apparatus;

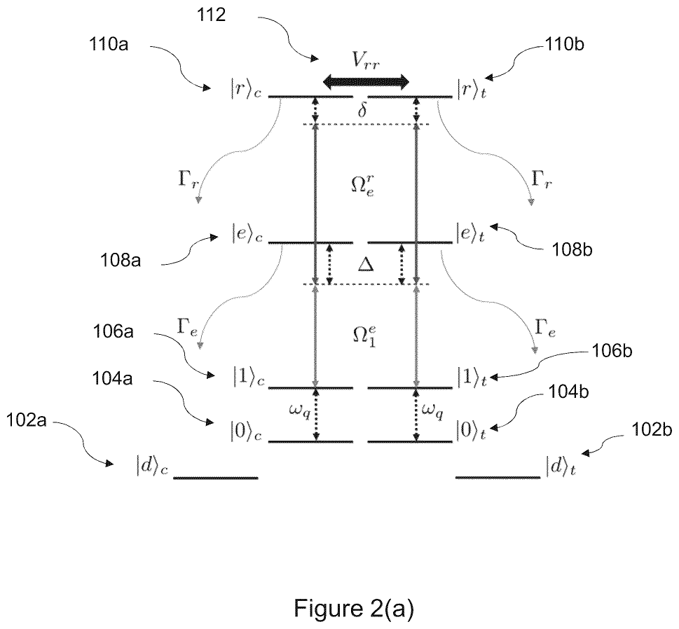

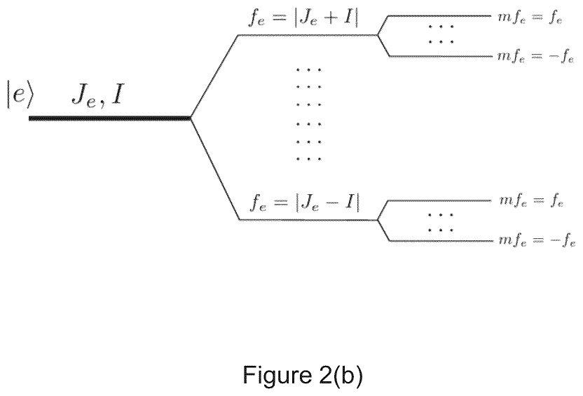

b. FIG. 2 (a) depicts a three-level energy level scheme and FIG. 2 (b) depicts hyperfine components of an intermediate state of the three-level energy scheme of FIG. 2(a);

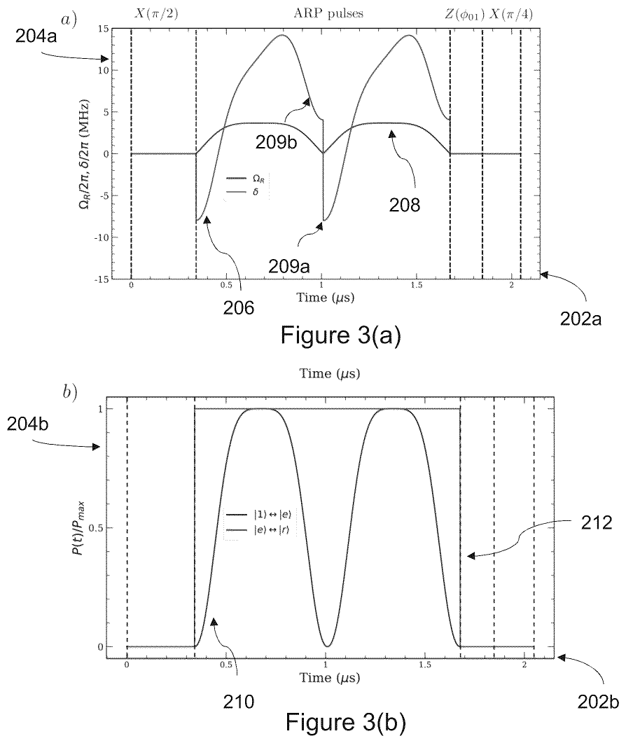

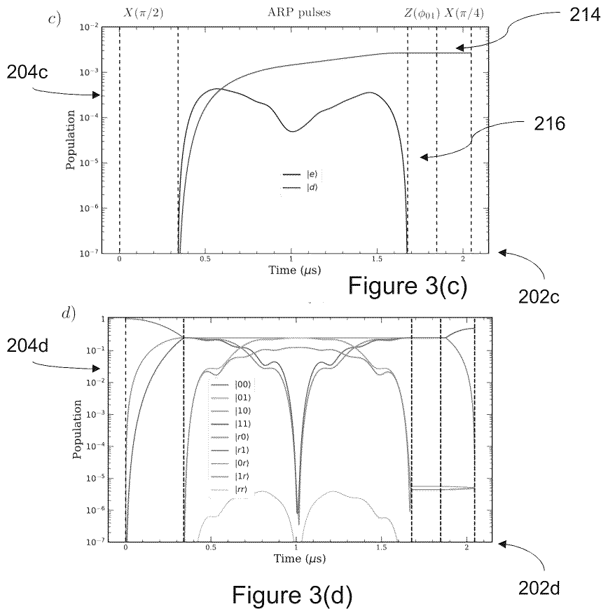

c. FIGS. 3(a) and 3(b) depict a variation of laser pulses over a pulse duration;

d. FIGS. 3(c) and 3(d) depict the resulting states and variation in state population of a quantum gate, as a result of the laser pulses of FIGS. 3(a) and 3(b), respectively, being incident on the quantum gate;

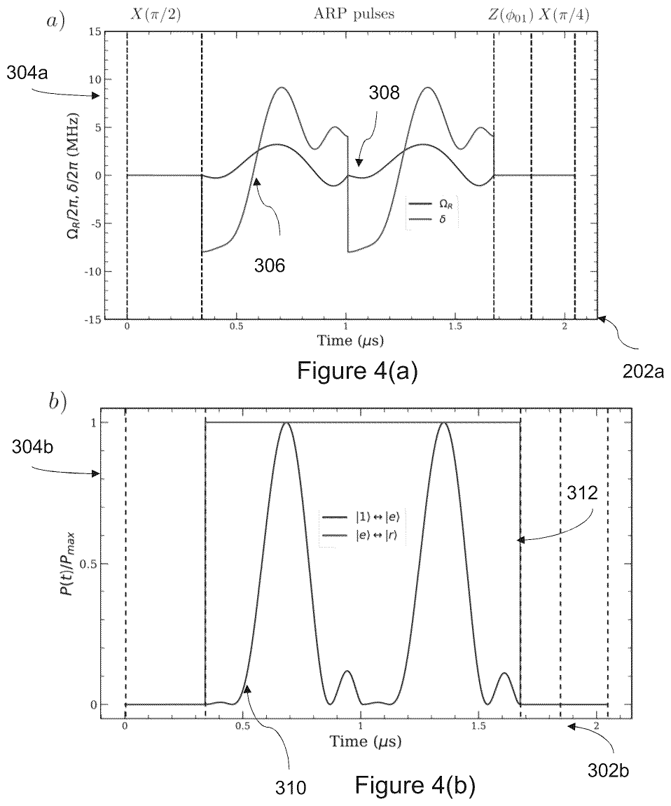

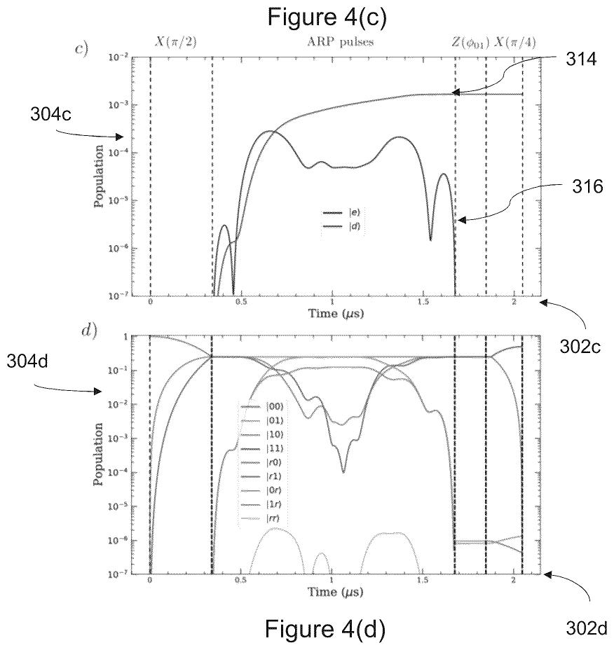

e. FIGS. 4(a) and 4(b) depict a pulse sequence of a two-photon excitation protocol, in accordance with further embodiments;

f. FIGS. 4(c) and 4(d) depict the resulting states and variation in state population of a quantum gate, as a result of the laser pulses of FIGS. 4(a) and 4(b), respectively, being incident on the quantum gate;

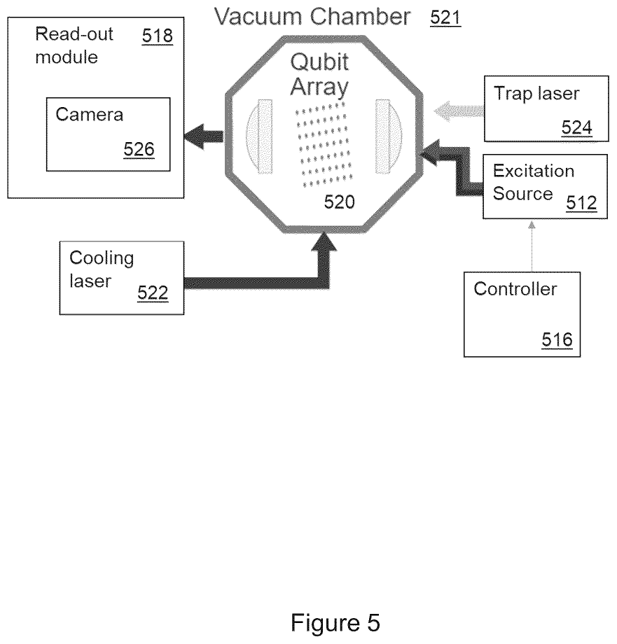

g. FIG. 5 depicts a further quantum computing apparatus; and

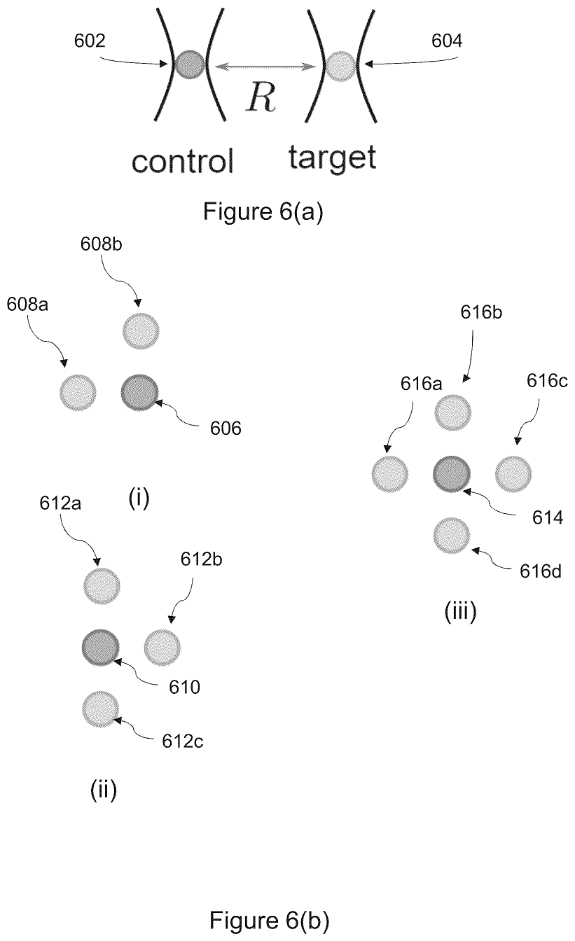

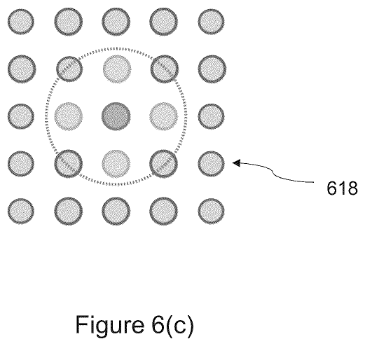

h. FIGS. 6 (a), 6 (b), and 6 (c) depict example qubit configurations.

i. FIG. 6(b)(i) depicts an example three atom configuration having a central control atom and two target atoms.

j. FIG. 6(b)(ii) depicts an example four atom configuration having a central control atom and three target atoms.

k. FIG. 6(b)(iii) depicts an example five atom configuration having a central control atom and four target atoms.

### DETAILED DESCRIPTION OF THE DRAWINGS

Embodiments described in the following describe adiabatic rapid passage (ARP) based gates for implementing two or more qubit quantum gates for the regime of two-photon transitions in neutral atoms. A neutral atom is any atom that is not charged. Suitable neutral atoms include alkali atoms, for example, sodium (Na), rubidium (Rb), caesium (Cs), and potassium (K) atoms. For the purposes of the following description a suitable neutral atom is a neutral atom that may be excited to a Rydberg atomic state (in which one or more electrons have a high quantum number n, for example, quantum number n greater than 50). In the following, a scheme to generate entanglement between two or more alkali-atom qubits excited to Rydberg levels through a two-photon process using ARP pulses is described.

By way of background, in its original form, ARP was designed to coherently transfer population between the states of a two-level system by adiabatically sweeping the Rabi frequency (represented by Ω(t)) and the detuning (represented by δ(t)) following an eigenstate of the two-level Hamiltonian. The methods described in the following use multi-level ladder systems in which the intermediate-state detuning is sufficiently large to allow for an effective two-level description through adiabatic elimination of the intermediate states.

In the described embodiments, the following methods incorporate accurate values of the atomic parameters for neutral atoms (in the described embodiments, Caesium atoms are used) and take into account the full hyperfine structure of the intermediate state. The methods described in the following have been shown to compete with the best, presently available two-qubit gates. Methods described in the following have been shown to achieve a Bell-state fidelity F≳0.997. With further pulse shaping based on optimal control, as described below, for example, with reference to FIG. 4, a Bell-state fidelity F˜0.998 may be achieved.

In the following methods of performing a quantum gate operation are described. It will be understood that such a method may comprise preparing a quantum state, for example, an entangled quantum state.

FIG. 1 depicts a quantum computing apparatus 10 having an excitation source 12, a quantum gate 14, a controller 16 and a read-out module 18. The quantum computing apparatus 10 is configured to perform a quantum gate operation on the quantum gate 14. The quantum gate 14 may also be referred to as a quantum system or part of a quantum system. In the present embodiment, the quantum gate is a controlled phase gate, however, it will be understood that other gates may be implemented, for example, a CNOT gate. It will be understood that, while the following method is described with reference to a controlled phase gate, the addition of single qubit rotations may allow other types of gates to be implemented. For example, the controlled phase gate is considered as the fundamental quantum gate, however, by applying a half phase pulse before and a half phase pulse after the described pulses on the target qubit, a CNOT gate is provided. These additional qubit rotations may be provided by a separate source, for example, a further laser.

It will be understood that FIG. 1 is provided as a schematic outline of part of a quantum computing apparatus 10 for the purposes of the description of a quantum gate operation. It will be understood that concepts described in the following may be scaled up and implemented into a quantum computer in a number of different ways. An example implementation of a quantum computer based on the quantum gate operations described in the following, is provided with reference to FIG. 5.

The quantum gate 14 comprises neutral atoms corresponding to or representing qubits. In the present embodiment, the quantum gate 14 has two qubits, as described in the following, such that the quantum gate 14 has two neutral atoms corresponding to a first and second quantum qubit. It will be understood that, while the present embodiment relates to a quantum gate 14 having two neutral atoms providing two qubits, the quantum gate 14 may have more than two neutral atoms.

The apparatus 10 has a controller 16. The controller 16 provides control of the excitation source 12. The controller 16 thus provides control of the quantum gate 14. In further detail, the control of the excitation source to generate a pulse sequence in accordance with a two-photon excitation scheme. Implementing the two-photon excitation scheme comprises controlling the excitation source 12 to generate the pulse sequence such that one or more pulses have the desired pulse properties. The pulse properties include, for example, the shape, size, amplitude and intensity of the pulses. The controller 16 may be any suitable circuitry or processing resource. The read-out module 18 is configured to read the quantum state of the qubit array. Control 16 of the excitation source may be performed by selecting and/or changing one or more operational parameters of the excitation source.

The excitation source 12 is a laser system configured to produce two-photon pulses. In the present embodiment, the excitation source 12 has a first laser and a second laser configured to generate excitation pulses for exciting the neutral atoms. The first and second lasers are arranged and configured to apply the excitation pulses simultaneously to the neutral atoms of the quantum gate 14.

In the present embodiment, the excitation source is a laser system with a corresponding optical modulation apparatus. In further detail, the present embodiment, has a first laser and a second laser, each having an electro-optical modulator (or, in other embodiments, an acousto-optic modulator). The electro-optical (or acousto-optic) modulator receives RF control signals that are generated by a pulse-generator to modulate the laser light generated by the respective laser thereby to change/select the properties of the laser pulses (for example, the frequency, amplitude and phase).

While electro-optical and acousto-optic control is described above, it will be understood that other types of modulator and methods of shaping laser pulses may be used in other embodiments. It will be understood that, in the following, while lasers are described as being controlled to generate laser pulses having desired shapes, the pulse shaping and control of the pulse properties may be provided by an optical modulator, as described above. It will be understood that in the present embodiment, the excitation source is controlled by obtaining pre-determined pulse sequence data, for example, from a storage resource. The pre-determined pulse sequence data is representative of the desired pulse sequence and is determined by performing a calculation that uses a dynamical model of the quantum system which is the subject of the pulse sequence. The model used has at least one part (for example, a component of a matrix or a term) that allows the effects of the hyperfine structure of the intermediate states of the neutral atoms on the dynamics of the quantum system to be modelled. The model allows the effect of these hyperfine components to be included in the calculation. In other embodiments, the pulse sequence data may be determined and used in real time.

For the present embodiment, the first and second lasers are arranged and configured to provide excitation pulses to the first and second neutral atoms simultaneously in accordance with a two-photon protocol. In addition, the first and second lasers provide the excitation pulses symmetrically to the first and second neutral atoms such that the same pulses are applied to each neutral atom. For embodiments with more than two neutral atoms, the first and second lasers are arranged and configured to provide the excitation pulses to all neutral atoms simultaneously and symmetrically in accordance with a two-photon protocol.

In the present embodiment, in which Caesium atoms are the neutral atoms, the first laser (non-resonantly coupling the intermediate state and the Rydberg state) has a wavelength of 1039 nm and the second laser (non-resonantly coupling the second hyperfine ground state and the intermediate states) has a wavelength of 459 nm. It will be understood that the laser wavelengths used are determined by atomic physics, and depend, for example, on the atom being excited. For example, for Rubidium, the wavelength of the first laser is 1004 nm and the wavelength of the second laser is 422 nm. The lasers used will typically have a wavelength in the range between 300 nm and 1500 nm.

Regarding power of the lasers, example maximum powers are provided below. For example, in one example, the maximum power of the first laser is 108.00 mW and the maximum power of the second laser is 20.23 mW and in another example, the maximum power of the first laser is 108.00 mW and the maximum power of the second laser is 17.70 mW. It will be understood that the power of each laser must be sufficient to allow variation of the power (of one or both of the lasers) to provide the desired change in effective Rabi frequency and therefore, variations in these values is possible. Lasers having a maximum power in the range 5 mW to 500 mW may be used, however, it will be understood that other values of power outside this range may be suitable depending on the experimental and system setup. For example, a laser having a maximum power above 500 mW may be used.

In operation, the controller 16 controls the excitation source 11 to generate excitation pulses to the neutral atoms of the quantum gate 14 in accordance with a two-photon excitation protocol. By providing excitation pulses to the quantum gate 14 in accordance with the two-photon excitation protocol to perform the quantum gate operation. The excitation protocol is described in further detail with reference to FIGS. 2, 3 and 4.

The two neutral atoms and their respective energy levels are depicted with reference to FIG. 2(a). As depicted in FIG. 2(a), the first neutral atom corresponds to a first qubit of the quantum gate 14, the control qubit and the second neutral atom corresponds to a second qubit of the quantum gate 14, the target qubit. In FIG. 2(a), the atomic states of the first neutral atom are accordingly assigned a subscript “c” (for control) and the states of the second neutral atom are assigned a subscript “t” (for target).

Each of the neutral atoms that form the quantum gate 14 (in this embodiment, the first and second neutral atoms) can be characterised by a set of atomic states such that each neutral atom can transition between said atomics states. Each neutral atom is moveable between these atomic states in response to the receiving or the emission of amounts of energy (e.g. via photons). For example, the neutral atom can be moved to a higher energy atomic state in response to interaction with an excitation pulse from the excitation source 12 or to a lower energy atomic state in response to interaction with a de-excitation pulse from the excitation source 12 or as a result of spontaneous emission.

In further detail, the first neutral atom is moveable between an uncoupled state 102a, a first ground state 104a, a second ground state 106a, an intermediate state 108a and an excited Rydberg state 110a. While only the states for the first neutral atom are described in the following, it will be understood that the second neutral atom has a set of corresponding states: an uncoupled state 102b, a first ground state 104b, a second ground state 106b, an intermediate state 108b and an excited Rydberg state 110b. In addition, in embodiments in which the quantum system has more than two neutral atoms (i.e. three or more) it will be understood that each neutral atom will be moveable between a corresponding set of atomic states.

In FIG. 2(a), while only a single intermediate state is depicted for each neutral atom, it will be understood that these intermediate states are resolved into hyperfine components of the intermediate atomic state. The hyperfine components of the intermediate atomic state are depicted in FIG. 2(b). FIG. 2(b) shows the fine splitting and the hyperfine splitting for an intermediate state of the three-level system of FIG. 2(a). The intermediate state for each neutral atom can therefore be considered as more than one distinct quantum state (i.e. a plurality of quantum states having different hyperfine quantum numbers).

As depicted in FIG. 2(b) the intermediate state |e [symbol] may be described by two or more hyperfine splittings due to the interaction between nucleus and electrons. Each intermediate state having total angular momentum quantum number Jₑ and fixed angular quantum number I, is split into a plurality of hyperfine structure components characterised by quantum number fₑ. The full hyperfine structure of the intermediate state includes fₑ taking all possible values in the set fₑ=|Jₑ+I|, . . . , |Jₑ+I−1|, . . . , |Jₑ−I|.

Each hyperfine component fₑ is degenerate as depicted in FIG. 2(b). The embodiments described in the following use a model that takes into account the hyperfine splitting into components fₑ.

For the first neutral atom (corresponding to the target qubit) the uncoupled state 102a is represented by |d [symbol] _{c} and accounts for all other hyperfine ground states of the first neutral atom. The first ground state 104a and the second ground state 106a of the first neutral atom correspond to computational states |0 [symbol] _{c} and |1 [symbol] _{c} of the first, control qubit, respectively. Likewise, for the second neutral atom, the uncoupled state 102b is represented by |d [symbol] ₜ and accounts for all other hyperfine ground states of the second neutral atom. The first ground state 104b and the second ground state 106b of the second neutral atom correspond to computational states |0 [symbol] ₜ and |1 [symbol] ₜ of the second, target, qubit respectively.

In the present embodiment, the first and second neutral atoms are Caesium atoms and are maintained at a temperature approaching T=0 Kelvin. It will be understood, that in practice, the temperature is maintained sufficiently low that the product of the Boltzmann constant and the temperature (K_{B}T) is lower than any relevant energy scales. In the present embodiment, the following states are selected: the first ground states 104a, 104b are each selected to be atomic state |0 [symbol] =|6S_{1/2}, f=3, m_{f}=0 [symbol] . The second ground states 106a, 108a are each selected to be the atomic state |1 [symbol] =|6S_{1/2}, f=4, m_{f}=0 [symbol] . The intermediate states 108a, 108b are selected to be the hyperfine components (the hyperfine splitting of quantum states) corresponding to the atomic state |e [symbol] =|7P_{1/2} [symbol] . As described above, the intermediate state |e [symbol] is resolved into its hyperfine components |fₑ, m_{f}_{ₑ} [symbol] . The excited Rydberg states 110a, 110b are each represented by the atomic state |r [symbol] =|82 S_{1/2} [symbol] . In embodiments with more than two neutral atoms, it will be understood that the atomic states of the third (or more) neutral atom will be selected to correspond to the above-described states of the other neutral atoms. The above states are provided as example states only. Suitable atomic states for the Rydberg states include any n that provides a sufficiently strong interaction (for example, n greater than 50).

For each neutral atom, the computational states |0 [symbol] and |1 [symbol] are encoded in hyperfine clock states that are separated by frequency ω_{q}. The uncoupled state |d [symbol] accounts for all other hyperfine ground states outside the computational basis. As described in further detail below, the second ground state |1 [symbol] of each neutral atom is coupled to the respective excited Rydberg state via a two-photon transition with an intermediate-state detuning Δ and a two-photon detuning δ. The pulse sequence of the two-photon protocol described in accordance with embodiments couples the computational states (the hyperfine ground states) to each other via both the intermediate states and the Rydberg states thus allowing electron population transfer between states.

As depicted in FIG. 2(a), there is an interaction 112 between the Rydberg states of the neutral atoms, characterised by potential Vᵣᵣ. This interaction may be referred to as a Rydberg-Rydberg or simply as a Rydberg interaction. This dipole-dipole interaction may be turned on and off by exciting and de-exciting the neutral atoms (i.e. by exciting electrons to the Rydberg level). The Rydberg interaction acts to prevent simultaneous excitation of the first and second neutral atoms to the Rydberg state. It will be understood that the intermediate state(s) are closer in energy to the first and second hyperfine ground states than to the Rydberg state. In embodiments with more than two neutral atoms, pair-wise Rydberg interactions are present between the neutral atoms thus preventing excitation of more than a single neutral atom. Further detail regarding suitable atomic configurations is provided with reference to FIGS. 6(a), 6(b), and 6(c).

Also depicted in FIG. 2(a) are the frequency levels and the frequency differences between the above described atomic states. In the following description, the quantity frequency is used to define a characterising difference between atomic states, however, it will be understood that the quantity of energy may also be used due to the relationship between photon energy and photon frequency. In the following, the Rabi frequencies and detuning of the quantum system are described and it will be understood that desired values of these quantities can be provided by lasers.

In the present embodiment, as depicted in FIG. 2(a), the hyperfine components of the intermediate state |e> and the Rydberg state are non-resonantly coupled (for example, by a first laser) by Rabi frequency Ωₑ^{r} and detuning δ. The second hyperfine ground state |1> and the hyperfine components of the intermediate state |e> for each atom are non-resonantly coupled (for example, by a second laser) providing Rabi frequency Ω₁^{e} and laser detuning Δe.

The centre of mass of the hyperfine components is detuned by Δ from the resonant transition frequency to |1>. The uncoupled level |d> represents all the hyperfine ground states different to |0> and |1> and accumulates the population lost by spontaneous emission from |e [symbol] and |r [symbol] with rates γₑ and γᵣ, respectively.

The parameters Ωₑ^{r} and Ω₁^{e} relate to the Rabi frequency for driving excitation from |1> to |e> and |e> to |r> for each intermediate hyperfine component state corresponding to the intermediate state (each component being represented by |fₑ, m_{f}_{ₑ}>). These frequencies, Ωₑ^{r} and Ω₁^{e}, are the Rabi frequencies of the individual lasers used and completely parametrize the Hamiltonian.

As described in the following, in order to implement the two-photon protocol and to control the quantum gate 14, an intermediate state detuning Δ is selected, in such a way that the two-photon excitation process can be effectively described by an effective Rabi frequency Ω_{R} and effective detuning δ_{R}. The parameter Δ is chosen so that it is large compared to the hyperfine splitting of the intermediate state to reduce the risk of having a near resonant transition with a hyperfine level. Such a resonant transition may introduce a large error,

Therefore, by suitable selection of the laser parameters, the three level system may be modelled as a two-level system. In particular, where the intermediate state is far-off resonance (i.e. has a value much larger than the Rabi frequencies) the intermediate states can be eliminated via adiabatic elimination. The superposition of all allowed transitions from the ground states to the Rydberg states via all hyperfine components of the intermediate state are included in the calculation. In this effective approximation, the two-photon Rabi frequency is defined as Ω_{R}=ΣₑΩₑ^{r}Ω₁^{e}/2Δₑ where the sum is performed over all intermediate excited states. In practice, the three-level system of FIG. 2(a) may be modelled using a Hamiltonian function that is dependent on the effective time-dependent Rabi frequency and time-dependent two-photon detuning. This approximation is valid in the regime where Δ>>Ωₑ^{r}, Ω₁^{e}.

The same effective parameters may be obtained for different values of Ωₑ^{r} and Ω₁^{e}, however, the full dynamics may not be equivalent. The effective detuning from |1 [symbol] to |r [symbol] is δ_{R}=δ+Δ_{AC} and is tuned to zero for resonant excitation, where Δ_{AC} is the combined AC Stark shifts Δ_{AC}=Σₑ([Ωₑ^{r}]²−[Ω₁^{e}]²)/4Δₑ. The sum for the combined AC stark shifts is a sum performed over the intermediate hyperfine states.

As described above, the three level quantum system can be effectively described using an effective Rabi frequency Ω_{R} and a two-photon detuning. The lasers are thus controlled over time to provide desired variations in these quantities. The effective Rabi frequency Ω_{R} is controlled by controlling laser power of the first and/or second laser and the two-photon detuning δ. is controlled by varying the frequency of the first and/or the second laser and/or by controlling the detuning of these lasers. In the described embodiments below, variations in the effective Rabi frequency are achieved by holding the first laser at a constant power and varying the power of the second laser in time. Likewise, variation in the two-photon detuning is achieved by chirping the frequency of either of the two lasers (in this example, the first laser). In the described embodiments, the second laser detuning Δ is kept constant, therefore any change in the first laser detuning corresponds to a change in the two-photon detuning δ. The second laser detuning is kept constant and is sufficiently large to allow for an effective two-level description through adiabatic elimination of the intermediate states.

As described above, the excitation source 12 has two lasers: a first laser and a second laser. In the present embodiment, the first laser has a power that is sufficient to non-resonantly couple the intermediate state with the excited Rydberg state and the second laser has the power sufficient to non-resonantly couple the second ground state and the intermediate state. The two-photon excitation scheme is described in the following with reference to FIGS. 3 and 4. It will be understood that the two-photon excitation scheme may be implemented by controlling one or more operational parameters of the excitation source.

In the present embodiment, the two-photon excitation scheme comprises generating a first excitation pulse from the first laser excitation to non-resonantly couple the intermediate state with the excited Rydberg state. The power of the first laser is locked such that the power of the laser remains constant for a first pulse duration. During the first pulse duration, the power of the second laser (non-resonantly coupling the second ground state |1 [symbol] and the intermediate state) is varied in time. This combination of changes in power provides the desired changes in the effective Rabi frequency. The second laser detuning is kept constant but sufficiently high that the intermediate state is far off the resonance between the second ground state and the intermediate state, and the first laser detuning is varied in time such that the variation in the two-photon resonance corresponds to the first laser detuning.

FIG. 3 (FIGS. 3(a)-3(d)) depicts an example of a preparation of Bell state |ψ [symbol] =(|00 [symbol] +|11 [symbol] /√2) starting with the state |00 [symbol] and using pulses provided in accordance with a first two-photon excitation scheme.

The two-photon protocol described implements a gate operation. The effect of the protocol can be described by a unitary operation for k+1 qubits given by:

$${U}_{{C}^{k} Z} = 2 ( {⊗}_{k + 1} \vert 0 〉 {⊗}_{k + 1} 〈 0 \vert ) - .$$

This operation is mathematical represented as diagonal matrix where the first entry is 1, and all other diagonals are −1.

Whether or not this gate generates entanglement is dependent upon the input applied—any arbitrary input state can be applied, and the evolution to the output state is described by the gate matrix U_{C}_{^{k}}_{Z} above. The |0 [symbol] component is unchanged, all other elements gain a factor of −1 on their complex amplitudes. Following the ramped pulses described in the following, the protocol require an additional global single qubit pulse Z(ϕ) to obtain the target U_{C}_{^{k}}_{Z} matrix.

The two-qubit controlled phase-gate

$${U}_{{C}^{k} Z}$$

is implemented using pulses provided in accordance with a first two-photon excitation scheme which may be considered as an adiabatic rapid passage protocol. Examples are depicted in FIG. 3 and FIG. 4. By combining the ARP pulses with single qubit global rotations, maximally entangled two-qubit states can be prepared.

FIGS. 3 and 4 depict an example of for preparation of Bell state |1ψ [symbol] =(|00 [symbol] +|11 [symbol] /√2) starting with the state |00 [symbol] . The state is prepared by applying a single qubit rotation

$$X ( \frac{π}{2} )$$

to the target qubit before the controlled phase gate UCZ, followed by a

$$X ( \frac{π}{4} )$$

to prepare the target Bell state. The timings and durations for the qubit phase rotations and the ARP pulses are depicted in FIGS. 3 and 4.

In the following two-photon excitation scheme, the first and second laser are controlled to emit pulse sequences. For all plots the intermediate-state detuning is Δ/2π=30 GHz and the Rydberg-Rydberg interaction strength is Vᵣᵣ/2π=578 MHz, the gaussian beam waists are w=3.5 μm and the maximum power of the second laser coupling the transitions between |1 [symbol] ↔|e [symbol] are 20.23 mW and the maximum power of the first laser coupling the transitions between |e [symbol] ↔|r [symbol] is 108.00 mW.

FIGS. 3(a) to 3(d) show plots of time dependence of properties of the laser and the populations of states of the neutral atoms. Each plot has time as an x-axis (202a, 202b, 202c, 202d) depicted in microseconds. In FIG. 3 (FIGS. 3(a)-3(d)), the pulses from the first laser and the second laser are incident on the neutral atoms for a period of time referred to in the following as a pulse duration. In particular, FIGS. 3(a) and 3(b) depict the variation of the laser pulses over a pulse duration and FIGS. 3(c) and 3(d) depict the resulting states and variation in state population of the quantum gate 14, as a result of the laser pulses being incident on the quantum gate 14. The excitation pulses are provided to the quantum gate as part of a pulse sequence. FIGS. 3(a) and 3(b) show the analytic pulse shapes for the two-photon protocol.

The laser chirps are directly related to the shape of line 208 (the two-photon detuning) in FIG. 3(a). Line 208 represents the total accumulated detuning between the two lasers. While it is described above that only one laser is chirped, it will be understood that both lasers may be chirped to provide the desired variations in the effective detuning (line 208).

FIG. 3(a) is a plot showing the time dependence of the effective single-photon Rabi frequency Ω_{R} (depicted by line 206) and the two-photon detuning δ (depicted by line 208) is shown. The two-photon detuning line 208 may also be referred to as detuning curve. The y-axis 204 in FIG. 3(a) is frequency. As is depicted in FIG. 3(a), the Rabi frequency has a time-dependent profile 206 that is has two repeating parts—each part having a first rising segment, a second plateauing segment and a third lowering segment. The detuning frequency has a profile 208 that likewise has two repeating parts—each part having three segments: a first segment that immediately drops the detuning frequency to a minimum value; a rising segment that takes the frequency from the minimum value to a maximum value; and a lowering segment that take the frequency from the maximum value to an intermediate value. The profile may therefore be characterised by an immediate drop followed by a peak at the maximum value.

In contrast to known pulse shapes that are described in “Symmetric Rydberg controlled—Z gates with adiabatic pulses” by Saffman et. al (Physical Review A 101, 2021), the change in shape from that smooth pulse of Saffman to the pulse depicted in FIG. 3(a) is mainly because when δ is changed, the atoms experience an effective detuning δ_{R}=δ+Δ_{AC}. The AC shift is a perturbative effect on the hyperfine components. These shifts are defined in terms of the individual Rabi frequencies involved in the process as this is a two-photon transition and is the defined as the combined AC Stark shifts Δ_{AC}=Σₑ([Ωₑ^{r}]²−[Ω₁^{e}]²)/4Δₑ (where the sum is over the intermediate hyperfine states).

Therefore, at least part of the shape of line 208 results from consideration of the hyperfine structure of the intermediate state. In particular, the detuning curve 208 has at least one feature that compensates for perturbative effects on the intermediate levels, such as AC Stark shifts. In particular, a first compensation feature in the form of a sharp fall 209a is present between the first and second part so that the shape is not a smooth function. For example, the sharp fall 209a between the first part and the second part of line 208. A second compensation feature is the presence of the lowering segment 209b. By including the full hyperfine structure in the calculation time-dependent AC Stark shifts and these shifts are compensated by these compensation features.

The two-photon protocol described herein takes into account the multi-level hyperfine structure of the intermediate state. If the hyperfine structure was neglected, the model would underestimate both the AC Stark shifts and any additional contribution to the spontaneous emission rates. In such a case, the calculated pulse shape may not result in high fidelity operations when implemented in the lab.

The shape of the two-photon detuning curve δ is selected to ensure that the effective detuning δ_{R} evolves smoothly following a similar smooth cosine profile as that presented in FIG. 2(a) of “Symmetric Rydberg controlled—Z gates with adiabatic pulses” by Saffman et. al (Physical Review A 101, 2021). The model used allows calculation of the exact detuning curve required in the lab frame to achieve the targeted fidelity. The detuning curve thus includes compensation features to allow a smooth effective detuning (the effective detuning being the sum of the two-photon detuning curve and the AC stark shifts. In general, without taking into account the full hyperfine structure of the intermediate state, the error would be underestimated and a shorter pulse would be optimised with reduced AC shift terms.

The allowable ARP pulse shapes are bounded by the adiabaticity condition. This can be expressed as:

$$\vert \dot{{δ}_{R} ( t )} \vert / {{Ω}_{R} ( t )}^{2} << 1$$

$$\vert \dot{{Ω}_{R} ( t )} \vert / {{Ω}_{R} ( t )}^{2} << 1$$

as δ_{R} depends on both δ and the individual Rabi frequencies via Ω² (due to the AC shift terms). These conditions define an acceptable parameter space for the lasers. While the two-photon detuning δ may have compensation feature that mean the detuning curve is discontinuous or has discrete steps, the total effective detuning curve δ_{R} will remain smooth.

FIG. 3(b) depicts the power profile of the two lasers assuming Gaussian beams and the time dependence of the power of the first laser and the second laser is shown. The Y-axis 204b in FIG. 3(b) is power (as a fraction of the maximum laser power) such that a value of 1 corresponds that the laser operating at a maximum value. As described above, the power of the first laser that non-resonantly couples the intermediate state and the Rydberg state remains constant for the pulse duration. The power of the first laser has a square shaped profile 212. The power of the second laser (that non-resonantly couples the second ground state with the intermediate state) is then continuously varied over the pulse duration and has a power profile 210 that is sine-shaped. The power of the second laser has a shape that is symmetric shape about a mid-point (that corresponds to half of the pulse duration). The shape may be considered as sine-like, however, more precisely, the shape is mathematically represented as the function exp{−(t−T)\hat{ }4}.

The combination of variation in power of the second laser to provide a variation in effective Rabi frequency and the variation in detuning of the first laser (to provide a variation in the two-photon detuning) provides for an adiabatic sweep over a range of frequencies that includes the resonant frequency between the second hyperfine ground state and the Rydberg atomic state. The detuning depicted in FIG. 3(a) refers to the two-photon detuning. The intermediate excited states are never resonant with the second hyperfine ground state and the population transfer occurs between the ground and Rydberg states.

FIG. 3(c) is a plot of the time evolution of the population of the intermediate state 216 and the dark ground states 214 of the neutral atoms. The Y-axis 204c in FIG. 3(c) is population. The intermediate state becomes populated as the lasers are turned on due to the finite intermediate-state detuning. As the intermediate state rapidly decays via spontaneous emission of light this produces an error, and this graph represents the leakage via the intermediate state out of the computational basis that is the dominant error in implementing the controlled gate. The intermediate state becomes populated as a result of turning on the power of the lasers. Towards the end of the process, the intermediate state becomes depopulated as a result of turning off the lasers, as well as due to the effect of spontaneous decay.

In FIG. 3(d), the time evolution and variation of the population of the computational and Rydberg states is shown. The Y-axis of FIG. 3(d) is population. FIG. 3(d) shows that the Bell state |ψ [symbol] =(|00 [symbol] +|11 [symbol] /√2) is substantially populated towards the end of the pulse sequence.

In order to account for the dissipative effects, the dynamics of the two-qubit density matrix ρ with the Lindblad master equation is determined and the Bell-state fidelity is calculated using the formula:

$$F = \frac{1}{2} ( {ρ}_{00 , 00} + {ρ}_{11 , 11} ) + \vert {ρ}_{00 , 11} \vert .$$

The first two terms are the populations of the states |00> and |11> and the final term is the coherence term between |00> and |11>. For the example depicted in FIG. 3, the fidelity is calculated as 0.9972.

FIG. 4 (FIGS. 4(a)-4(d)) depicts a further pulse sequence in accordance with the two-photon excitation scheme. FIG. 4 is a modified version of the pulse sequence described with reference to FIG. 3. In further detail, the pulses are modulated using a standard optimal control, which in this embodiment, based on a Fourier series expansion. Applying known optimal control pulse shaping to the ARP gate protocol, the fidelity may be improved further by reducing the power of the second laser (coupling the |1 [symbol] and |e [symbol] states). The pulse sequence of FIG. 4 can be considered as an optimized version of the pulse sequence of FIG. 3. As such the reference numerals of FIG. 4 are numbered to correspond to those described above for FIG. 3. Example of optimal quantum control may be found, for example, in Phys Rev. A 84, 022326 (2011).

The further modulation comprises varying at least one of the shape, amplitude, intensity duration of the pulse. The further modulation may comprise varying the time-dependent changes in the single effective Rabi frequency and the single detuning parameter. In the present embodiment, the quantum optimal control process is performed by numerically optimising parameters of an envelope function that is expanded as a sum of orthogonal functions. The numerical optimisation process may comprise applying a numerical solver to find said values for the pulse parameters. While in the present embodiment, the calculation and optimisation is performed off-line (prior to performing any gate operations), in other embodiments, optimisation may be performed in situ. For example, an optimisation may be performed in response to performing calibration measurements. Such an approach requires the calculation time to be comparable to the read-out rate.

In all of the plots in FIG. 4 (FIGS. 4(a)-4(d)), the intermediate-state detuning is Δ/2π=30 GHz and the Rydberg-Rydberg interaction strength is Vᵣᵣ/2π=578 MHz, the Gaussian beam waists are w=3.5 μm and the maximum power of the second laser coupling the transitions between |1 [symbol] ↔|e [symbol] are 17.70 mW and the maximum power of the first laser coupling the transitions between |e [symbol] ↔|r [symbol] is 108.00 mW. In regions of FIG. 4, where the effective Rabi frequency is negative, a π phase factor must be incorporated in either the Rabi frequency of the |1 [symbol] ↔|e [symbol] or the |e [symbol] ↔|r [symbol] excitation. In the example shown in FIG. 4, the Bell-state fidelity is F=0.9983. While the above laser parameters are provided, it will be understood that these are provided as a non-limiting example and the above method would work for lasers with comparable intensity (for example, by maintaining the same ratio of Power/w².

In FIG. 4 (a), the time dependence of the effective single-photon Rabi frequency 306 and the two-photon detuning 308 is shown. In contrast to FIG. 3(a), additional modulation to the shapes of these profiles can be observed. In further detail, the Rabi frequency has a profile 306 that has two repeating parts. In contrast to the FIG. 3(a), each part has four segments: a first lowering segment (to take the frequency from an initial value of zero to a first negative value); a second rising segment (to take the frequency from the first negative value to its maximum value), a third lowering segment (to take the frequency from the maximum value to a minimum value) and a four rising segment to take the frequency from the minimum value to its initial value. In contrast to FIG. 3(a), the Rabi frequency takes negative values and does not have a plateau. The first to fourth segments form a continuous smooth function for each part, however, there is a discontinuity between the first and second parts. Each part may be characterised by a peak and a (smaller) nadir.

In FIG. 4 (b), the time dependence of the two-photon detuning 308 is depicted. As described with reference to FIG. 3(a), the profile 308 has two repeating parts, however, the shape is modified in contrast to FIG. 3(a). In particular, in contrast to profile 208 which has an immediate drop and then rise to a maximum peak, the profile 308 also has an additional, secondary peak that follows the maximum peak—the secondary peak is lower than the maximum peak. In full, the profile 308 has two repeating parts—each part having five segments: a first segment that immediately drops the detuning frequency to a minimum value; a first rising segment that raises the detuning frequency to a maximum value; a first lowering segment that lowers the detuning frequency to an intermediate value; a second rising segment that raises the detuning frequency to a second intermediate value; and a second lowering segment that lowers the detuning frequency to a third intermediate value.

FIG. 4(b) depicts the power profile of the first laser (312) and the second laser (line 310) assuming Gaussian beams. The additional modulation to the power profile of the second laser can be observed by comparison with FIG. 3(b). While the power profile of the first laser 312 corresponds to the power profile 212 of the first laser, as described with reference to FIG. 3(b), the power profile of the second laser 310 is varied in comparison to the power profile 210. In particular, the power is varied so that a measure of the total power applied (in this case, the integral of the power profile) is lower than that of FIG. 3(b). The power profile 310 is a modulated version of the symmetric sine-like shape profile 210. More precisely, each part of the power profile 310 varies in time as a symmetric exponential function (exp{(T₀−t)⁻⁴}) for the analytic case of FIG. 3. It will be understood, that in other embodiments, the pulse has a different non-trivial form.

The power profile has two repeating parts: each part having three segments: a first segment that has a low peak, a second segment that has a high peak (that reaches the maximum available power) and a third segment with an intermediate peak. The power profile 310 may therefore be characterised by a first and second, lower peak.

FIG. 4(c) depicts the time evolution of the population of the intermediate states 314 and the dark ground states 316 is shown. In contrast to FIG. 3(c) variations in the population due to the additional modulation can be observed. In FIG. 4(d) the time evolution and variation of the population of the computational and Rydberg states is shown. In contrast to FIG. 3(d) improvements in population of the Bell-state can be observed.

As a benchmark of the ARP protocol described above, Bell-state fidelities corresponding to the known protocols were determined yielding F=0.9983. Compared to known, single-photon protocols, and the fidelities found show that the above-described method may provide a competitive alternative approach to fast two-qubit gates.

The embodiments described above may offer a number of advantages over known methods and systems. For example, in comparison to known methods, multi-level hyperfine shifts are considered and without such considerations, the fidelity of the gate operation may be limited.

While the above-described embodiments mainly relate to two atom quantum gates, it will be understood, that the method may apply to multi (i.e. more than two) qubit gate protocols. Such multi-qubit gates may be implemented with exactly the same modality (global addressing of multiple qubits) with the same architecture considered for the two qubit gates. The advantage of natively implementing multi-qubit gates is that it avoids the requirement to separate higher-order gates into lots of one and two-qubit gates (for example the three-qubit gate we optimise is equivalent to six separate two-qubit operations) and thus allows enhanced parallelism and improved fidelity.

While the above description relates to performing a quantum gate operation on a single gate, it will be understood that a quantum computing apparatus having a plurality of such quantum gates may be provided, in accordance with further embodiments. It will be further understood that a quantum computing apparatus based on the above method of controlling a quantum gate may be implemented in a number of different ways. FIG. 5 depicts a non-limiting example of how such a quantum computing apparatus may be implanted. It will be understood that the quantum gate defined above may be applied on any other subset of qubits within a qubit array simply by changing which atoms are addressed by the lasers. Example configurations of qubits are described with reference to FIGS. 6(a), 6(b), and 6(c).

The system depicted in FIG. 5 has a number of components that correspond to those described with reference to FIG. 1. For example, FIG. 5 has a controller 516 corresponding to controller 16 for performing gate operations, an excitation source 512 corresponding to excitation source 12 and a read-out module 518 corresponding to read out module 18.

As described with reference to FIG. 1, the excitation source comprises lasers may also be referred to as Rydberg lasers. The system has a qubit array 520 (also referred to a neutral atom array) provided in a vacuum chamber 521. The qubit array provides one or more quantum gates that correspond substantially to quantum gate 14.

Separately from the controller 516 and the excitation source 512, the quantum computer further has a neutral atom control apparatus for controlling the neutral atom array. In particular, the neutral atom control apparatus comprises further lasers for initialising/loading and maintaining the neutral atom array (for example, by cooling, transporting and trapping the neutral atoms). In particular, as depicted in FIG. 5, the system has a cooling laser 522 for qubit initialisation and a trap laser 524 for trapping the neutral atoms. The neutral atom array may be an optical or magnetic neutral atom array. The neutral atom array 520 has a plurality of neutral atoms to provide a quantum register of qubits. The qubits may comprise both computational qubits and ancillary qubits.

The read-out module 518 corresponds to the read-out module 18 of FIG. 1 and is configured to read the state of the one or more quantum gates of the neutral atom array 520. The read-out module 518 may be any suitable device for capturing the state of the neutral atom. In the embodiment of FIG. 5, the read-out module comprises a camera 526 and associated circuitry for performing fluorescence imaging.

FIGS. 6(a), 6(b), and 6(c) depict non-limiting examples of neutral atom configuration for multiple qubits. It will be understood that these neutral atom configurations may form part of a larger neutral atom array (for example, the neutral atom array 520). As depicted in FIGS. 6(a), 6(b), and 6(c). FIG. 6(a) depicts an example of a two atom configuration with a control atom 602 and a target atom 604 labelled. The separation distance between the two atoms is labelled R.

FIG. 6(b) depicts examples for a three, four and five atom configuration. FIG. 6(b)(i) depicts an example three atom configuration having a central control atom 606 and two target atoms 608a, 608b. The three atoms are arranged in a right-angled triangular shape.

FIG. 6(b)(ii) depicts an example four atom configuration having a central control atom 610 and three target atoms 612a, 612b, 614c. The three target atoms are arranged in a triangular shape with the control atom provided in the centre. FIG. 6(b)(iii) depicts an example five atom configuration having a central control atom 614 and four target atoms 616a, 616b, 616c, 616d. The four target atoms are arranged in a diamond shape with the control atom 614 provided centrally within the diamond. FIG. 6(c) depicts the five atom configuration of FIG. 6(b)(iii) provided in a qubit array. The five atom configuration is depicts surrounded by further atoms 618. FIG. 6(c) is an example of how a quantum gate can be applied on different subsets of qubits in an array by changing which atoms are addressed by lasers.

It will be understood that configurations with more than two neutral atoms will have corresponding pairwise Rydberg interactions. For example, the configuration of three atoms will have three Rydberg interactions.

Using similar parameters and global excitation scheme as described above, optimal pulse sequences that enable three-qubit UCCZ have been found to provide fidelity F>0.995 (requiring two-qubit gate fidelities F>0.999 to compete with performance). In addition, pulse sequence that enable four qubit UCCCZ with F>0.99 have been found.

A skilled person will appreciate that variations of the enclosed arrangement are possible without departing from the invention.

For example, in the above described embodiment, the first and second lasers are described as being controlled by a controller controlling a suitable optical modulation apparatus, however, it will be understood that in alternative embodiments, the laser may be provided with a further pulse shaping apparatus (for example, an optical apparatus) that is also or alternatively controlled by the controller to generate the excitation pulses. Alternatively, the laser itself may be configured to be controlled to produce the desired pulse sequences.

Accordingly, the above description of the specific embodiment is made by way of example only and not for the purposes of limitations. It will be clear to the skilled person that minor modifications may be made without significant changes to the operation described.

What is claimed is:

1. A method of performing a quantum gate operation using a quantum system wherein the quantum system comprises two or more neutral atoms, wherein each atom of the two or more neutral atoms is configured to transition between atomic states comprising: a first hyperfine ground state of the atom, a second hyperfine ground state of the atom, a Rydberg state and at least one intermediate excited state, wherein the quantum system further comprises an interaction between the Rydberg states of the two or more neutral atoms, and wherein the method comprises:
generating a pulse sequence and providing the generated pulse sequence to the two or more neutral atoms to transition the atoms between said atomic states, wherein the pulse sequence takes into account at least part of the hyperfine structure of the at least one intermediate atomic state.

2. The method according to claim 1, wherein the quantum gate operation corresponds to an evolution of the at least two neutral atoms between said atomic states and wherein the pulse sequence comprises at least one property based on a calculation or application of a model of the quantum system that includes an effect of at least one hyperfine component of the at least one intermediate state on said evolution.

3. The method according to claim 2, wherein the at least one property comprises at least one of: a shape, size, amplitude, frequency or duration of the pulse.

4. The method according to claim 2 further comprising selecting and/or varying an operational parameter of a pulse generator thereby to generate said pulse sequence having said at least one property.

5. The method according to claim 1, wherein the at least one property of the pulse sequence is represented by one or more pulse parameters and the method comprises obtaining values for the one or more pulse parameters based on said calculation or applying the model.

6. The method according to claim 2, wherein at least one pulse of the sequence of pulses is characterised by a frequency detuning curve, wherein the frequency detuning curve comprises at least one compensation feature to compensate for a perturbative effect on the one or more hyperfine components of the intermediate state.

7. The method according to claim 6, wherein the compensation feature comprises a discontinuity, a rate of change, an adjustment in rate of change, a maxima, minima or turning point, a peak and/or a nadir.

8. The method according to claim 1, wherein generating the pulse sequence comprises:
controlling at least one laser to generate at least one chirped excitation pulse, where the chirped excitation pulse comprises a sweep over a range of frequencies that include at least the two-photon resonance frequency between the second hyperfine ground state and the Rydberg state.

9. The method according to claim 1, wherein generating the pulse sequence comprises:
generating a first pulse comprising a range of frequencies that is sufficient to non-resonantly couple the at least one intermediate atomic state and the Rydberg state and
generating a second pulse comprising a sweep over a range of frequencies that includes the resonant frequency between the first hyperfine ground state and the Rydberg state.

10. The method according to claim 1, wherein at least one of a), b), c) d):
a) the pulse sequence comprises a two-photon adiabatic rapid passage (ARP) protocol;
b) the pulse sequence is characterised by time-dependent changes in at least an effective Rabi frequency and a two-photon detuning parameter;
c) the generated pulse sequence comprises energies based on the energy separation of the ground hyperfine levels and the intermediate and Rydberg states subject to a selected detuning value;
d) wherein the pulse sequence comprises applying single qubit rotations.

11. The method according to claim 1, wherein the quantum system is represented by a first model having a first number of dimensions and wherein the pulse sequence is generated as part of a time dependent detuning process over a sufficiently large frequency range such that that the quantum system can be effectively represented by a second model having a second, lower, number of dimensions.

12. The method according to claim 11, wherein the detuning process is such that the quantum system may be characterised by a single effective Rabi frequency and a single detuning parameter.

13. The method according to claim 1, wherein the method further comprises performing a further modulation to the generated pulse sequence, wherein the further modulation is based on a quantum optimal control process.

14. The method according to claim 1, wherein at least one of a), b), c):
a) the transitions between atomic states comprise Rabi oscillations;
b) preparing the entangled quantum state is provided as part of a quantum gate protocol.

15. The method according to claim 1, comprising providing the generated pulse sequence symmetrically to the two or more neutral atoms.

16. The method as claimed in claim 1, wherein the two or more neutral atoms comprise alkali atoms.

17. The method as claimed in claim 1, wherein the two or more neutral atoms comprise one of: sodium (Na), rubidium (Rb), caesium (Cs), and potassium (K) atoms.

18. The method according to claim 1, wherein the Rydberg interaction between the Rydberg state of the two or more neutral atoms prevents simultaneous excitation of the two or more neutral atoms to their respective Rydberg states.

19. A quantum computer apparatus comprising:
a quantum system comprising two or more neutral atoms, the two or more neutral atoms comprising, wherein each atom of the two or more neutral atoms is configured to transition between atomic states comprising: a first hyperfine ground state of the atom, a second hyperfine ground state of the atom, a Rydberg state and at least one intermediate atomic state, wherein the quantum system further comprises an interaction between the Rydberg states of the two or more neutral atoms;
a pulse generator configured to generate a pulse sequence and provide the generated pulse sequence to the two or more neutral atoms in accordance to transition the atoms between said atomic states, wherein the pulse sequence comprises at least one pulse comprising a property that takes into account at least part of the hyperfine structure of the at least one intermediate atomic state.

20. A method comprising:
performing a calculation to determine a pulse sequence for a quantum system, wherein the determined pulse sequence is such that a desired quantum gate operation is obtained, wherein the quantum system comprises two or more neutral atoms, the two or more neutral atoms, wherein each atom of the two or more neutral atoms is configured to transition between atomic states comprising: a first hyperfine ground state of the atom, a second hyperfine ground state of the atom, a Rydberg state and at least one intermediate excited state, wherein the quantum system further comprises an interaction between the Rydberg states of the two or more neutral atoms, and wherein the calculation takes into account at least part of a hyperfine structure of the at least one intermediate state;
storing pulse sequence data representative of the determined pulse sequence.
